(19) United States
(12) Patent Application Publication
(10) Pub. No.: US 2007/0134452 A1
(43) Pub. Date: Jun. 14, 2007

(54) Component and use thereof and method for the production thereof

(75) Inventors: Christian Merkle, Pluderhausen (DE); Walter Wolf, Oppenweller-Zell (DE)

Correspondence Address: FOLEY AND LARDNER LLP;SUITE 500, 3000 K STREET NW, WASHINGTON, DC, 20007, US

(73) Assignee: BEHR GMBH & CO. KG, Stuttgart (DE)

(21) Appl. No.: 10/574,773

(22) PCT Filed: Oct. 8, 2004
(86) PCT No.: PCT/EP04/11281

§ 371 Date: Dec. 13, 2006

(30) Foreign Application Priority Data
Oct. 8, 2003 (DE) 103 47 230.4
Mar. 2, 2004 (DE) 10 2004 010 606.1

(51) Int. Cl. B31B 45/00; B29D 22/00

(52) U.S. Cl. 428/34.1; 428/192; 428/122

(57) ABSTRACT

The invention relates to a component (1), especially a hybrid component for a crossrail of a vehicle, comprising a metal base body (2) which is at least partially provided with a plastic structure (6). The metal base body (2) comprises a fixing element (12) which is formed on the edge area thereof (Rg) and which is used to at least mechanically attach the base body (2) to the plastic structure (6).

The invention relates to a component, in particular a hybrid component for a crossrail, and to the use thereof. Furthermore, the invention relates to a method for the production of a component.

Crossrails that are formed from hollow profiles, for example from a tube or a half shell, consist of metal and have appropriately large wall thicknesses are known from automobile construction. Here, the wall thicknesses are designed with the appropriate thickness for satisfactory dimensional stability, flexural strength, buckling strength and torsional strength, as well as for a satisfactory loadability in compression. The crossrail designed as a hollow profile is suitable in principle for guiding air, for example toward lateral outflows from an air conditioning system arranged centrally in the front region of the vehicle.

Such a component is known, for example, from EP 0 995 668 A1, which exhibits a hollow chamber lightweight component comprising at least a shell-shaped housing part made from high strength material, a ribbed support structure made from plastic, and at least one cover plate or cover shell made from a high strength material, in particular different from plastic. In this case, the support structure is connected at its edge region to at least a part of the border of the housing part by virtue of the fact that the support structure and the housing part are connected by means of injection-molded self-closed plastic connections at sites lying directly on one another in the region of apertures lying one above another. It is also possible for the housing part to be partially or completely sheathed or encapsulated with thermoplastic. A plastic surrounded by the metal housing part can give rise in this case to deformations of the component. Again, the freedom to shape the support structure or plastic reinforcement is limited. In addition, a complex mold is required to produce the through bend at the apertures or discrete connecting sites.

It is therefore the object of the invention to specify a component, in particular a hybrid component for a crossrail of a vehicle, that is of particularly simple design and has a simple connection between the metal base body and plastic structure.

The object with regard to the component is achieved according to the invention by means of the features of the independent claim 1, and with regard to the uses of such a component by means of the features of the independent claims 19 to 21. The invention is achieved with regard to the method for producing such a component by means of the features of the independent claim 22.

Advantageous developments of the invention are the subject matter of the subclaims.

The invention proceeds in this case from the consideration that instead of a complex prefabrication of a metal base body with apertures for producing discrete connecting sites with a plastic structure, the aim should be to enable a connection between the base body and plastic structure that furthermore manages without additional elements. Moreover, the connecting site should ensure the best possible superficial force transmission. To this end, the metal base body has on its edge region an integrally formed fixing element with the aid of which the plastic structure can be at least mechanically joined to the base body. In other words: the connection of the metal base body to the plastic structure is performed in a largely mechanical fashion at their edges lying one above another by mechanically reshaping, in particular flanging, the integrally formed fixing element of the base body. To this end, given a metal base body designed as a hollow profile, the integrally formed fixing element is itself formed by its, one- or two-sided edge running along the longitudinal axis.

In the simplest embodiment, the edge running over the entire length of the base body is flanged, that is to say bent over. Flanging is understood, in particular, as bending over the edge of the base body, if appropriate while simultaneously stretching or compressing the edge, in order to reinforce the latter, such that the base body is formed in a stiffening fashion or is alternatively or in addition provided with smooth edge surfaces or peripheral surfaces at which, in addition, the base body can be connected to the plastic structure, for example by soldering, screwing or folding.

In one alternative embodiment, the fixing element, formed as an edge, of the metal base body has a comb structure. Here, the comb-like or crest-like edge (=integrally formed fixing element) of the metal base body is bent around the edge region of the plastic structure, in particular flanged, such that the metal base body is mechanically connected to the plastic structure. In addition to the flanged connection of the base body to the plastic structure, a comb-like or crest-like edge additionally enables a latching connection or clamped connection by means of an appropriate formation of the edge region of the plastic structure. To this end, the edge region of the plastic structure is constructed with a surface shape or integral formation corresponding in the recess of the comb-like edge of the base body.

In addition or as an alternative, the integrally formed fixing element can be designed as a latching element. To this end, the fixing element can be designed as a recess or arch in the edge region of the base body. Moreover, the plastic structure is preferably provided in its edge region with projections that can be fitted, in particular inserted, plugged or latched, into the comb structure and/or into the latching element in the edge region of the metal base body. In other words, the projections of the plastic structure correspond in their edge region to the comb structure and/or the latching element in the edge region of the metal base body such that when they lie one above another the two edge regions can be positioned and fixed, as well as connected, in a simple mechanical way.

To fix the plastic structure on the metal base body mechanically as reliably as possible and sufficiently firmly, the integrally formed fixing element at least partially surrounds the plastic structure in the edge region. In particular, the integrally formed fixing element surrounds the plastic structure at least in a U-shape fashion. In order to increase the strength of the mechanical connection, the metal base body and the plastic structure can be mechanically connected one above another in a number of steps in the edge region. For example, the integrally formed fixing element can surround the plastic structure in a U-shape fashion per step. In the case of a comb-like design of the integrally formed fixing element, the latter surrounds, in particular embraces, the plastic structure with the aid of the comb structure. In this case, depending on how the comb structure surrounds, the plastic structure has on the upper and/or lower side of the edge region projections that correspond on the upper and/or lower side of the associated edge region of the plastic structure and which are suitable for fixing, for example latching or clamping, in the comb structure.

Additionally or alternatively, the integrally formed fixing element can be provided with at least one structural element, in particular with a rib, a web, a knob, an aperture. This ensures a sufficiently good strength, in particular buckling strength, of the edge region of the metal base body. In addition, these structural elements can support the mechanical connection by virtue of the fact that the surface of the plastic structure in the edge region corresponds to the structural elements of the edge region of the metal base body.

In one possible embodiment, the plastic structure can be inserted, in particular fitted, into a cavity in the metal base body. In this case, the plastic structure can on the one hand be designed as a separate module that is inserted into the metal base body. To this end, the plastic structure can be positioned and fixed by means of the integrally formed fixing element. On the other hand, the plastic structure can, for example, be gated, attached and/or fitted at least partially in the manner of a plastic lining. For example, to this end the plastic lining is introduced in a method step by so-called conventional or multicomponent injection molding, and be shaped as a plastic structure, the latter also covering the edge region of the metal base body.

Expediently, the plastic structure can be fitted, in particular clipped, pinched, hooked and/or inserted with the aid of a flange connection, plug connection, snap connection, clip connection, caulked connection and/or hook connection in its edge region into the metal base body by means of the integrally formed fixing element in a self-closed and/or force-closed fashion. Moreover, the plastic structure can be connected by means of the integrally formed fixing element in its edge region to the metal base body in a bonded fashion with the aid of an adhesive-bonded connection, an injection molded plastic connection, soldered connection and/or welded connection.

In addition, the plastic structure can be connected to the metal base body in the edge regions thereof by means of a separate connecting element, in particular a clasp, for example a U-shaped clasp. For example, the clasp can be arranged in fashion embracing the flanged edge region of the base body in which the edge region of the plastic structure is at least partially held.

Depending on the type and function of the component, the plastic structure can be designed as a stiffening structure and/or a guide structure. For example, the plastic structure can form a guide duct or flow duct in which a medium, for example air, is guided for the air conditioning of a vehicle cabin. Alternatively or additionally, the plastic structure can be designed as a cable duct. Additionally or alternatively, the plastic structure can be designed at least partially as an internal ribbing for stiffening the metal base body. Also, the plastic structure can be a combination element composed of an internal ribbing and a duct. In a further embodiment, the plastic structure can be of unipartite or multipartite design. For example, the plastic structure can form a duct in the cavity of the metal base body and, in the upwardly open region of the cavity, for example in the opening region of a half shell, of the metal base body, be embodied as a ribbed cover that stiffens the open region as well as possible.

The plastic structure is expediently formed from a thermoplastic, in particular from a fiber-reinforced and/or filled plastic. The metal base body is preferably formed from a light metal, in particular aluminum, magnesium or titanium, or from fine steel, and has a wall thickness of 0.4 mm to 3 mm, in particular of 0.4 mm to 1.5 mm. Depending on the function and type of the component, for example as a crossrail in the vehicle or as an air guide duct, the metal base body is embodied as a hollow profile, in particular as an open hollow profile, with an edge running along the longitudinal axis of the hollow profile on one or both sides, for example as a hat profile.

The base body provided at least partially with plastic can advantageously be of perforated design at least in some regions. This is expediently performed in an opening region, for example. Such a base body has, in particular, the advantage of saving weight, and/or of reinforcing the structure.

The component described is preferably used as a dashboard carrier in a vehicle, the plastic core or the plastic structure forming one or more ducts, in particular an air guide duct and/or a cable duct. Alternatively, such a component can be used as a crossrail in a vehicle, in particular as a crossrail between the A-pillars of a vehicle or as a front end component. Also possible is the use of such a component as a carrier element in a vehicle, in particular as an A-, B-, C-, D-pillar carrier element, as chassis rail, as vehicle door sill or as roof post.

Use is made in the method for producing the component described of, for example, an already prefabricated metal base body that is provided in its edge region with an integrally formed fixing element. A plastic structure to be accommodated in the cavity in the metal base body is positioned and fixed in the prefabricated metal base body, the integrally formed fixing element of the metal base body being reshaped such that the plastic structure is connected at least mechanically, in particular flanged, in its edge region to the metal base body. In one possible embodiment, the fixing element in the edge region of the metal base body is bent at least in a u-shaped fashion about the edge region of the plastic structure.

In particular, the interconnected edge regions of the metal base body and of the plastic structure are interconnected in a self-closed, force-closed and/or bonded fashion, for example flanged, pressed, stamped, riveted, screwed, welded, soldered and/or bonded. In addition, the mechanically interconnected edge regions of the metal base body and of the plastic structure can be interconnected by means of a separate connecting element, in particular a clasp, a clip, a screw.

Depending on the design and function of the component, the metal base body can be provided with an edge forming the fixing element, and can be used as a prefabricated module. Alternatively, the metal base body can itself be shaped during the mechanical connection of the edge regions, the base body being arranged in a stamping die for this purpose. Again, the plastic structure can be used as a prefabricated module, in particular as a unipartite or multipartite module. Alternatively, the plastic structure can be introduced into a prefabricated metal base body by introducing plastic in a so-called conventional or multicomponent injection molding method, and be shaped as a plastic structure. For example, the plastic structure is produced by injection molding, injection-compression molding, press molding polymer melts reinforced with long glass fiber, with or without fiber mat reinforcement.

The advantages achieved with the aid of the invention consist, in particular, in that a component having a high degree of freedom to be shaped is produced. In this case, the metal base body can be connected to the plastic structure in the edge region in a fashion extending over a large area, doing so without additional parts. Moreover, it is possible to use as material for the plastic structure a long glass fiber material that increases the stiffness and strength of the component. Moreover, the large-area connection of base body and plastic structure renders it possible to transmit force between the components over an area or along a line. In addition, owing to the large-area connecting site, it is possible to use the latter for further types of connection such as bonded connections, for example glued ones.

Exemplary embodiments of the invention are explained in more detail with the aid of a drawing, in which:

FIGS. 1A, 1B show a schematic cross section of a possible embodiment of a component having a metal base body and a plastic structure that are mechanically connected in their edge regions,

FIGS. 2A to 2C show schematically the production sequence for producing the mechanical connection of metal base body and plastic structure,

FIGS. 3A to 4B show a schematic cross section of various embodiments of a component having different types of connections of metal base body and plastic structure,

FIGS. 5A, 5B show a perspective schematic of a component having a base body with a comb-type integrally formed fixing element in the edge region, and

FIGS. 6A to 7 show a perspective schematic of further embodiments of a component having fixing elements of various types in the edge region of the base body.

### Mutually corresponding parts are provided in all figures with the same reference symbols.

FIG. 1A shows a cross section of a component 1, for example a crossrail, intended to be arranged between A-pillars (not illustrated in more detail) of a vehicle (not illustrated in more detail).

The component 1 is a hybrid component, in particular. To this end, the component 1 has a metal base body 2 that is preferably formed from sheet metal, in particular from a light metal sheet, for example from aluminum sheet or magnesium sheet or from fine steel sheet, with a wall thickness of 0.4 mm to 3 mm, in particular from 0.4 mm to 1.5 mm or 2.0 mm. Moreover, the base body 2 can be shaped with a thickness that varies in some regions such that the component 1 can be integrated in part with further elements, for example a steering assembly or an air conditioning system or air inlets and/or air outlets.

The base body 2 is designed in the exemplary embodiment as a hollow profile, in particular as a U profile or box profile. In this case, the base body 2 has in the upwardly open region of the U profile or of the split shell an overhang or an edge region Rg that runs along the longitudinal axis of the base body 2. Consequently, the base body 2 can also be denoted as a hat profile. Alternatively, the metal base body can also be designed in a tubular fashion, for example as a hollow cylinder. In this embodiment (not illustrated in more detail), the base body 2 is formed from two elements that are provided with edge regions in the regions lying one above another. Also, the box-shaped or U-shaped base body 2 can comprise two elements. This is dependent, in particular, on the use of the component 1. For example, the opening region 0 of the upwardly open base body 2 can be provided with a cover 4 that is formed, depending on the function and type of the component 1, from plastic or metal, in particular a light metal.

The base body 2 is provided on the inside with plastic K that forms a plastic structure 6. The plastic K can be attached, fitted or gated here in the manner of a plastic lining. In the closed state, the base body 2 lined at least partially with plastic K serves as a duct 8, in particular as a flow duct and/or guide duct for guiding a flow or for guiding cables or other components. Depending on the design of the plastic structure 6, the duct 8 can be formed as a single compartment duct or a multicompartment duct. In the case of a multicompartment duct, the plastic structure 6 additionally has a partition wall 10 (illustrated by dashes). The plastic structure 6 serves the purpose, in particular, of stiffening the base body 2 (formed from light metal, for example), in order to prevent a deformation of the base body 2 when it is subjected to the action of forces.

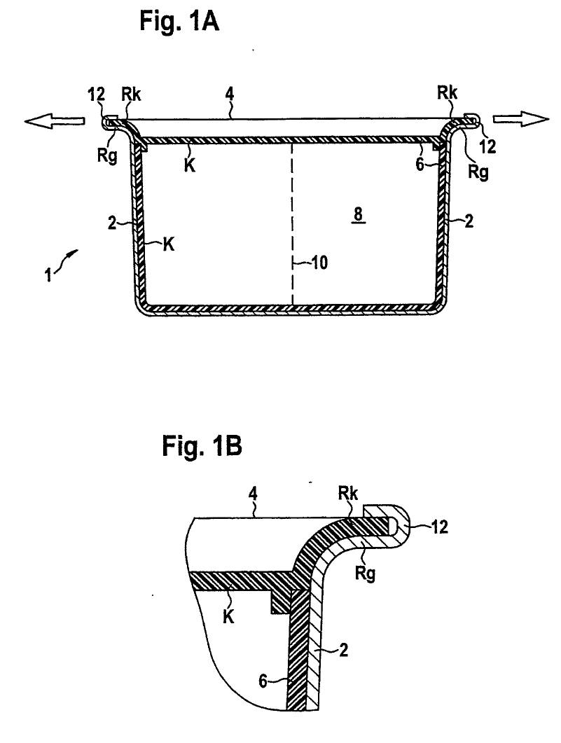

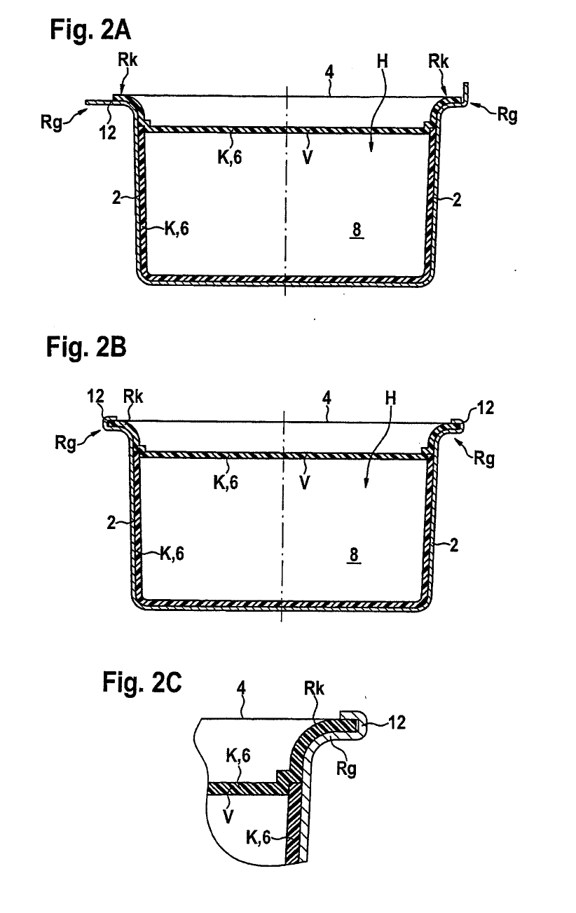

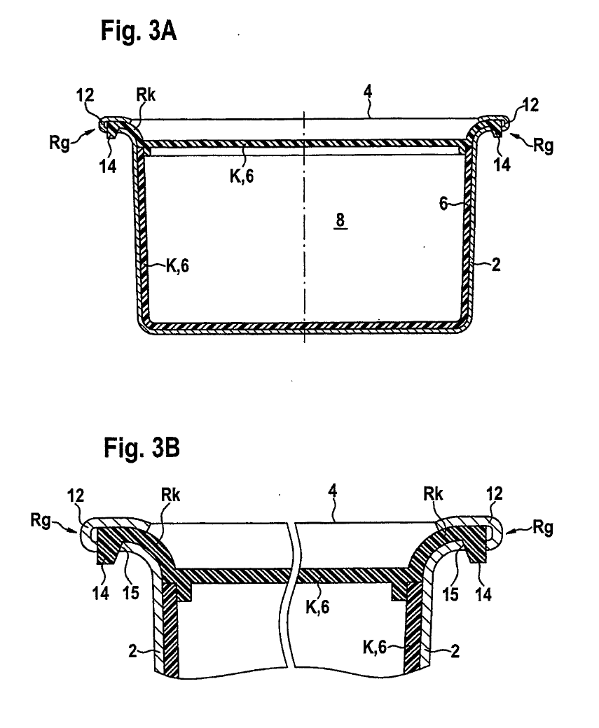

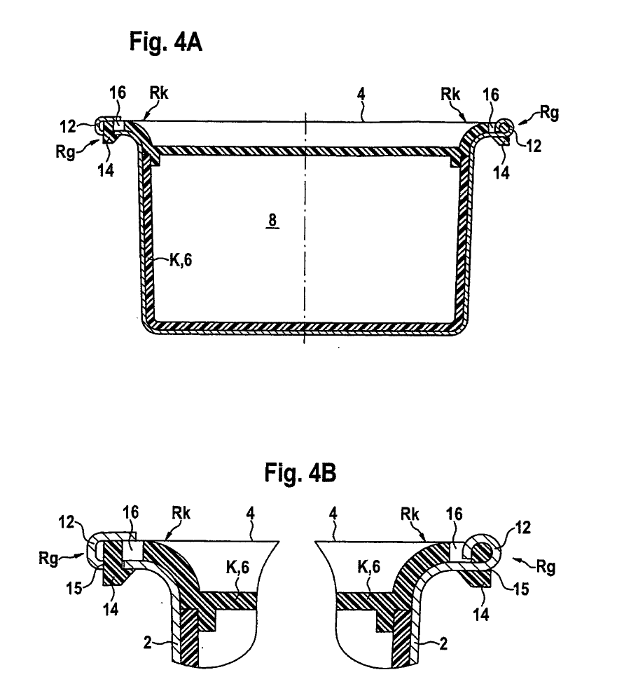

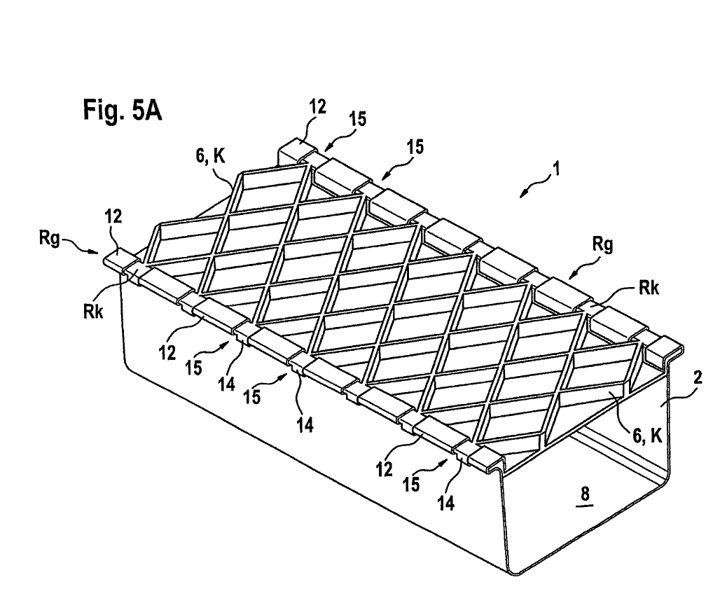

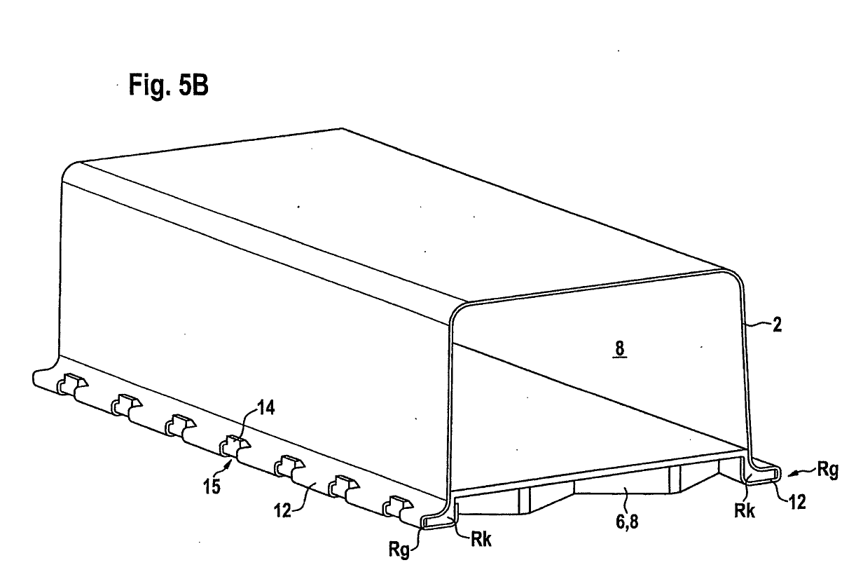

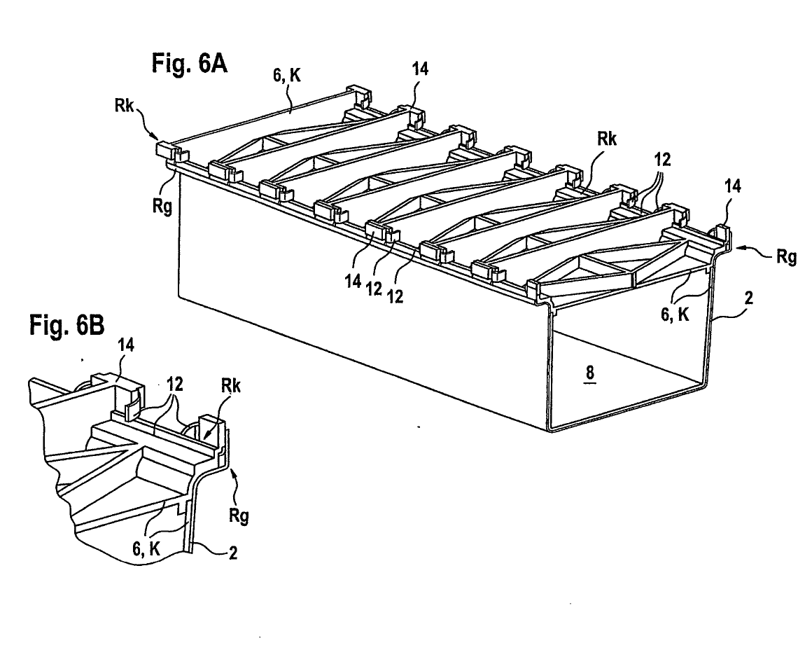

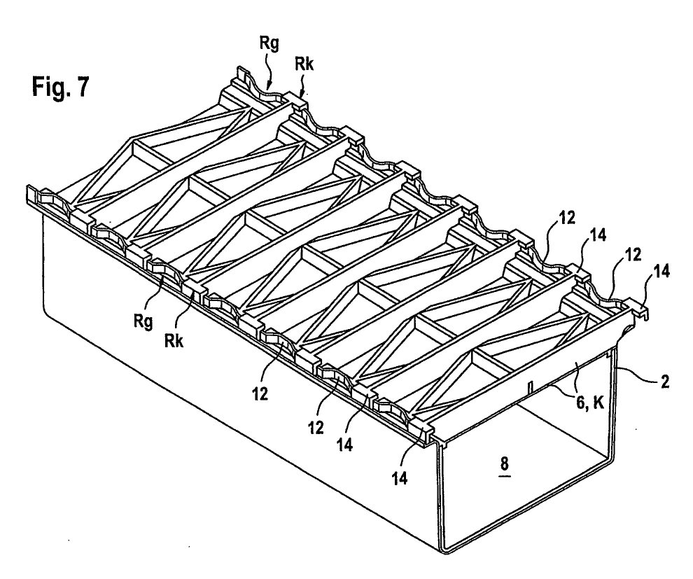

The base body 2 and plastic structure 6 are to be interconnected sufficiently firmly for the purpose of the best possible use of the channel 8, formed by means of the plastic structure 6, for guiding a medium, for example guiding air to air-condition a vehicle cabin, or for guiding lines or cables, and for the purpose of reducing the mechanical stressing, resulting therefrom, of the component 1, in particular the application of forces for the connection between said base body and plastic structure. To this end, the plastic structure 6 is attached with its associated edge region Rk to the edge region Rg of the base body 2. The edge region Rg of the base body 2 is provided with integrally formed fixing elements 12 with the aid of which the plastic structure 6 is at least mechanically joined, in particular flanged. Here, the mechanical connection between the metal base body 2 and the plastic structure 6 is formed mechanically at their edges Rg and Rk, respectively, lying one above another in such a way that the integrally formed fixing element 12 is bent, in particular flanged, about the edge region Rk of the plastic structure 6. In the simple embodiment of the large-area connection between the metal base body 2 and the plastic structure 6 in the edge regions Rg and Rk, respectively, the integrally formed fixing element 12 surrounds the edge region Rk of the plastic structure 6 in a U-shape fashion, as is illustrated in more detail in FIG. 1B in an enlarged section in accordance with FIG. 1A.

FIGS. 2A to 2C schematically show the fabrication sequence for producing the mechanical connection between the metal base body 2 and plastic structure 6. As illustrated in FIG. 2A, in this case the plastic structure 6 is inserted, in particular fitted, into a cavity H that serves, for example, as a duct 8, in the base body 2. If appropriate, the plastic structure 6 is positioned and prefixed above the fixing element 12 in the cavity H. In order to connect the base body 2 to the plastic structure 6 over an area and in a self-closed fashion in the edge regions Rg and Rk, respectively, lying one on top of another, the respective fixing element 12 is reshaped, in particular bent over, such that the fixing element 12 surrounds the edge region Rk of the plastic structure 6, in particular in a U-shape fashion as illustrated in FIG. 2B and in FIG. 2C in the enlarged section.

Depending on the type of component, both the metal base body 2 and the plastic structure 6 can be designed as prefabricated modules that are joined, in particular set, inside one another, and whose edge regions Rg and Rk, respectively, are interconnected, in particular flanged, by means of the fixing element 12. Alternatively, the plastic structure 6 can be formed from a number of elements, one element representing the plastic lining of the cavity H. The other element is arranged as stiffening structure V in the form of an internal ribbing in the opening region of the base body 2 below the cover 4 as plastic structure 6. Independently of the type of lining, the plastic layer or plastic lining or the stiffening structure has—in injection-molded or attached form—a thickness of 1 mm to 10 mm, preferably between 0.8 mm and 6 mm, depending on stipulation. The base body 2 can be provided with plastic K on the inside and/or outside. Moreover, by introducing it in a number of phases, plastic can be integrally formed in one layer or a number of layers on the base body 2.

FIGS. 3A to 4B show a schematic cross section of various embodiments of a component 1 having different types of connections of metal base body 2 and plastic structure 6 in their edge regions Rg and Rk, respectively.

In addition to the flanged connection of the edge regions Rg and Rk, FIGS. 3A and 3B (enlarged section from FIG. 3A) show a further connection, which arises from providing the edge region Rk of plastic structure 6 with a projection 14, for example a plastic lug that engages in a cutout 15 in the fixing element 12 and the edge region Rg of the base body 2 such that fixing is possible.

FIGS. 4A and 4B (enlarged section from FIG. 4A) show a further refinement of the connection between base body 2 and plastic structure 6. Here, the plastic structure 6 has in its edge region Rk a recess 16 into which the fixing element 12 is bent and thereby latches (see right-hand edge regions Rg, Rk). As is shown in FIGS. 3A and 3B, it is possible here, as well, for the projection 14 of the edge region Rk of the plastic structure to latch into a cutout 15 in the edge region Rg of the base body 2.

FIGS. 5A, 5B show a perspective schematic of a component 1 having a base body 2 with a comb-type integrally formed fixing element 12 in the edge region Rg. The comb structure of the edge region Rg, and thus the comb-type fixing element 12, is bent, in particular flanged, about the edge region Rk of the plastic structure 6, which is illustrated here solely as a stiffening structure. In addition, the plastic structure 6 can once again be provided with projections 14 that engage, for example clip, latch, clamp in the cutouts 15 formed by the comb structure of the fixing element 12.

FIGS. 6A and 6B show a perspective schematic of a further embodiment of a component 1 having a fixing element 12 of various types in the edge region Rg of the base body 2. Here, the fixing element 12 is designed as a latching element in which projections 14 of the edge region Rk of the plastic structure 6 engage, in particular latch, clamp or clip. FIG. 7 shows a further embodiment of a fixing element 12 having a latching function.

In addition, the fixing element 12 can be provided in the edge region Rg of the base body 2 with ribs, webs, knobs and/or apertures (not illustrated in more detail). Here, the plastic structure 6 is then shaped in its edge region Rk by injection pressure and provided with a corresponding surface structure. Depending on the shape, type and number of the fixing elements 12, it is possible to implement any desired shapes and patterns, for example longitudinal grooves, transverse grooves, cruciform patterns or hexagonal patterns, that correspond to the structure of the fixing element 12, as fixing surface structure for the plastic structure 6 in the edge region Rk.

In addition, the plastic structure 6 can be connected in its edge region Rk to the metal base body 2 in a bonded fashion with the aid of an adhesive-bonded connection, an injection-molded plastic connection, soldered connection and/or welded connection. This is possible in the case of all the above-described embodiments of a component 1. Again, the plastic structure 6 and the metal base body 2 can be connected in their edge regions Rg, Rk by means of a separate connecting element, in particular a clasp, for example a U-shaped clasp.

The component 1 serves, for example, as a dashboard carrier for an air conditioning system and/or heating system. Alternatively, the component 1 can serve as a crossrail, arranged below a windshield pane, in a vehicle that is provided as an air guide duct for air-conditioning the vehicle cabin and for deicing the windshield pane or front pane. The base body 2 is provided with a number of opening regions, arranged at a spacing from one another when seen in the longitudinal direction, for the entry and/or exit of a medium, for example air, guided in the duct 8.

Furthermore, such a component 1 can also be used at other sites in a vehicle. Examples are A-, B-, C-, D-pillars, chassis rails, vehicle door sills, roof posts, etc. Again, air can be guided through these components 1 to an air conditioning system (termed HVAC for short) in a space-saving fashion and distributed, the component 1 being embodied as a structural part in the vehicle, in particular as a hollow structural part.

### LIST OF REFERENCE SYMBOLS

1 Component
2 Base body
4 Cover
6 Plastic structure
8 Duct
10 Partition wall
12 Integrally formed fixing element
14 Projection
15 Cutout
16 Recess
H Cavity
K Plastic
Rg Edge region of the base body
Rk Edge region of the plastic structure

1. A component, in particular a hybrid component for a crossrail of a vehicle, comprising a metal base body that is at least partially provided with a plastic structure, the metal base body having on its edge region an integrally formed fixing element with the aid of which the plastic structure can be at least mechanically joined to the base body.

2. The component as claimed in claim 1, in which, given a metal base body designed as a hollow profile, the integrally formed fixing element is itself formed by an edge running along the longitudinal axis.

3. The component as claimed in claim 1, in which, given a metal base body designed as a hollow profile, the integrally formed fixing element is formed by an edge running along the longitudinal axis that has a comb structure.

4. The component as claimed in claim 1, in which the integrally formed fixing element is designed as a latching element.

5. The component as claimed in claim 1, in which the plastic structure is provided in its edge region with projections that can be fitted, in particular inserted, plugged or latched, into a comb structure and/or into a latching element in the edge region of the metal base body.

6. The component as claimed in claim 1, in which the integrally formed fixing element at least partially surrounds the plastic structure in the edge region thereof.

7. The component as claimed in claim 1, in which the integrally formed fixing element surrounds the plastic structure at least in a U-shape fashion.

8. The component as claimed in claim 1, in which the integrally formed fixing element surrounds, in particular embraces, the plastic structure in a comb-like fashion in the edge region thereof.

9. The component as claimed in, in which the integrally formed fixing element is provided with at least one structural element, in particular with a rib, a web, a knob, an aperture.

10. The component as claimed in claim 1, in which the plastic structure can be inserted, in particular fitted, into a cavity in the metal base body, and can be positioned and fixed by means of the integrally formed fixing element.

11. The component as claimed in claim 1, in which the plastic structure can be fitted, in particular clipped, pinched, hooked and/or inserted with the aid of a flange connection, plug connection, snap connection, clip connection, caulked connection and/or hook connection in its edge region (Rk) into the metal base body by means of the integrally formed fixing element in a self-closed and/or force-closed fashion.

12. The component as claimed in claim 1, in which the plastic structure is additionally connected in its edge region to the metal base body in a bonded fashion with the aid of an adhesive-bonded connection, an injection molded plastic connection, soldered connection and/or welded connection.

13. The component as claimed in claim 1, in which the plastic structure can additionally be connected to the metal base body in the edge regions thereof by means of a separate connecting element, in particular a clasp, for example a U-shaped clasp.

14. The component as claimed in, in which the plastic structure is designed as a stiffening structure and/or a guide structure.

15. The component as claimed in claim 1, in which the plastic structure (6) is of unipartite or multipartite design.

16. The component as claimed in claim 1, in which the plastic structure is formed from a thermoplastic, in particular from a fiber-reinforced and/or filled plastic.

17. The component as claimed in claim 1, in which the metal base body is formed from a light metal, in particular aluminum, magnesium or titanium, or from fine steel, and has a wall thickness of 0.4 mm to 1.5 mm.

18. The component as claimed in claim 1, in which the metal base body is embodied as a hollow profile, in particular as an open hollow profile, with an edge running along the longitudinal axis of the hollow profile on one or both sides, for example as a hat profile.

19. The use of a component 4 as claimed in as a dashboard carrier in a vehicle having a duct, in particular an air guide duct and/or a cable duct.

20. The use of a component as claimed in claim 1 as a crossrail in a vehicle, in particular as a crossrail between the A-pillars of a vehicle or as a front end component.

21. The use of a component as claimed in claim 1 as a carrier element in a vehicle, in particular as an A-, B-, C-, D-pillar carrier element, as chassis rail, as vehicle door sill or as roof post.

22. A method for producing a component as claimed in claim 1, in which a metal base body is provided in its edge region with an integrally formed fixing element in which a plastic structure to be accommodated in a cavity in the metal base body is positioned and fixed, the integrally formed fixing element of the metal base body being reshaped such that the plastic structure is connected at least mechanically in its edge region to the metal base body.

23. The method as claimed in claim 22, in which the fixing element is bent at least in a U-shape fashion about the edge region of the plastic structure.

24. The method as claimed in claim 22, in which the interconnected edge regions (Rg, Rk) of the metal base body and of the plastic structure (6) are interconnected in a self-closed, force-closed and/or bonded fashion, in particular flanged, pressed, stamped, riveted, screwed, welded, soldered and/or bonded.

25. The method as claimed in claim 22, in which the interconnected edge regions of the metal base body and of the plastic structure are additionally interconnected by means of a separate connecting element, in particular a clasp, a clip, a screw.

26. The method as claimed in claim 22, in which the metal base body is provided with an edge forming the fixing element, and is used as a prefabricated module.

27. The method as claimed in claim 22, in which the plastic structure is used as a prefabricated module, in particular as a unipartite or multipartite module.
